(19) United States
(12) Patent Application Publication
(10) Pub. No.: US 2026/0193471 A1
(43) Pub. Date: Jul. 9, 2026

(54) ARTICLES WITH EMBEDDED PIGMENTS

(71) Applicant: PPG Industries Ohio, Inc., Cleveland, OH (US)

(72) Inventors: Andrew Philip Loughner, Pittsburgh, PA (US); Vijesh Anant Tanna, Pittsburgh, PA (US); Michael Anthony Bubas, Pittsburgh, PA (US); Kerianne Merceline Dobosz, Pittsburgh, PA (US); Bret Michael Boyle, Pittsburgh, PA (US); Scott Joseph Moravek, Mars, PA (US); Corey James DeDomenic, Trafford, PA (US); Abdulrahman Dawoud Ibrahim, Wexford, PA (US); Vincent Salvatore Pagnotti, Jr., Wexford, PA (US)

(73) Assignee: PPG Industries Ohio, Inc., Cleveland, OH (US)

(21) Appl. No.: 19/133,842

(22) PCT Filed: Dec. 6, 2023
(86) PCT No.: PCT/US2023/082626

§ 371 Date: May 29, 2025

Related U.S. Application Data
(60) Provisional application No. 63/386,196, filed on Dec. 6, 2022.
(60) Provisional application No. 63/514,226, filed on Jul. 18, 2023.

(51) Int. Cl. C09D 5/03; C09D 5/22; C09D 5/33; C09D 5/38

(52) U.S. Cl. CPC C09D 5/035; C09D 5/004; C09D 5/22; C09D 5/38

(57) ABSTRACT

Disclosed herein is an article of manufacture made by ambient reactive extrusion, the article includes a) a hardenable composition; and b) a pigment component that includes a pigment and/or a particle. The pigment component can be applied to at least a portion of a surface of the article when the hardenable composition is at least partially unhardened, such that the pigment and/or the particle becomes embedded upon hardening.

### CROSS-REFERENCE TO RELATED APPLICATION

This application claims the benefit of priority of U.S. Provisional Application 63/386,196 filed Dec. 6, 2022, under 35 U.S.C. 119, titled “Coatings with Embedded Pigments” and U.S. Provisional Application 63/514,226 filed Jul. 18, 2023, under 35 U.S.C. 119, titled “Articles with Embedded Pigments”, the latter is incorporated herein by reference.

### FIELD

This disclosure generally relates to an article made by ambient reactive manufacturing in which pigments and/or particles are embedded, and methods for making same.

### BACKGROUND

Improved methods for manufacturing articles and imparting visual and/or other effects to these articles are desired.

### SUMMARY

The present disclosure is directed to an article of manufacture made by ambient reactive extrusion that includes a) a hardenable composition; and b) a pigment component that includes a pigment and/or a particle. The pigment component is applied to at least a portion of a surface of the article when the hardenable composition is at least partially unhardened, such that the pigment and/or a particle becomes embedded upon hardening.

The present disclosure is further directed to an article of manufacture made by using ambient reactive extrusion to deposit a hardenable composition to form a three-dimensional article; applying a pigment component that includes a pigment and/or a particle to at least a portion of a surface of the article when the hardenable composition is at least partially unhardened; and hardening the hardenable composition.

Methods for making such articles are also within the present disclosure.

The present disclosure is also directed to a screw conveyor adapted to convey a pigment component from an auger sleeve to an auger discharge.

### FIGURES

FIGS. 1a and 1b show a depiction of a cross-section of a three-dimensional article described herein before (1a) and after (1b) embedding pigments and/or particles as described herein.

FIG. 2 shows a depiction of a cross-section of a three-dimensional article described herein.

FIG. 3 shows scanning electron microscopy (SEM) and energy dispersive X-ray spectroscopy (EDX) images of the three-dimensional article of Example 1, Samples 1-4.

FIG. 4 shows macroscope images of a cross section of the three-dimensional article of Example 2.

FIG. 5 is a perspective view of a screw conveyor that can be used according to this disclosure.

FIG. 6 is a side elevation view of a screw conveyor without auger sleeve or auger housing that can be used according to this disclosure.

FIG. 7 is a front elevation view of an auger that can be used in the screw conveyor according to this disclosure.

### DETAILED DESCRIPTION

The present disclosure is directed to an article of manufacture made by ambient reactive extrusion that includes a) a hardenable composition; and b) a pigment component that includes a pigment and/or a particle, wherein the pigment component is applied to as least a portion of a surface of the article when the hardenable composition is at least partially unhardened, such that the pigment and/or particle becomes embedded upon hardening. The present disclosure is further directed to an article of manufacture made using ambient reactive extrusion to deposit a hardenable composition to form a three-dimensional article; applying a pigment component that includes a pigment and/or a particle to at least a portion of a surface of the article when the hardenable composition is at least partially unhardened; and hardening the composition. Methods for making such articles are also within the scope of the present disclosure.

As used herein, “ambient reactive extrusion” (“ARE”) and like terms refer to an additive process whereby layers of material, such as a hardenable composition, are built up to create a three-dimensional part, such as creating a three-dimensional article by applying layer on top of layer of a curable or hardenable composition. ARE may use coreactive compositions; that is, at least two components that react with each other (i.e., are “coreactive”). A first coreactive component (sometimes referred to herein as a first reactant group, a first reactive functional group, or part A) and at least one second coreactive component (sometimes referred to herein as a second reactant group, second reactive functional group, or part B), when extruded in combination and/or succession, chemically react with one another to form a hardenable composition. The hardenable composition may thereafter cure, or harden, under ambient conditions or, depending on the chemistry of the reaction, with the assistance of heat (temperatures above ambient), actinic radiation, catalysts, addition of curing agents-post extrusion, and the like to form an article, including a portion of an article of manufacture. Such compositions are referred to herein as “curable”, “hardenable”, or similar terms because of the ability of at least a portion of their polymerizable and/or crosslinkable components to undergo a reaction. “Crosslinkable” refers to a molecule or polymer containing a functional group reactive with a functional group of another molecule or polymer. Hardenable, cure, harden, and like terms may be used interchangeably herein.

Similarly, “cure potential”, “hardening potential” or like terms refer to the amount of reaction that can potentially occur in a composition determined by the amount of reactive functional groups and, in some cases, crosslinking agents, present in a composition. A hardenable composition that is “at least partially unhardened” therefore refers to partial cure/hardening; in other words that not all of the polymerizable or crosslinkable components in the composition have reacted; and that the polymerizable or crosslinkable components can continue to react. A partial cure or hardening of X % cure/hardening potential indicates that X mol % of the reactive functional groups present have reacted, where X represents the number of moles of reactive functional groups capable of undergoing reaction that have reacted divided by the total moles of reactive functional groups capable of undergoing reaction. By applying the pigment component to the partially unhardened composition of the article, the pigment and/or a particle becomes embedded in the article as cure/hardening continues.

As used herein, “embed”, “embedded” and like terms refer to enclosing, either partially or completely, in the hardenable composition. Pigments and/or particles according to the present disclosure can be completely embedded or only partially embedded in the hardenable composition.

Any hardenable composition suitable for use with ARE can be used according to the present disclosure. This broadly includes thermosetting polymers (sometimes referred to as a thermoset), thermoplastic polymers, or combinations thereof. The coreactive components are chosen by one skilled in the art to result in the desired hardenable composition from which to formulate the article.

Articles according to the present disclosure are additively manufactured by extruding the hardenable composition onto a surface, such as a build platform. The hardenable composition may be in an at least partially reacted state at the time of extrusion and thereafter fully react and cure to form a layer of the hardenable composition. Successive layers of the same and/or different hardenable compositions can be deposited, forming additional layers of material. The combination of layers forms the article. The hardenable composition may be at least partially reacted when the coreactive components come together, such as in a mixing volume, just prior to extrusion. Alternatively, the two coreactive components can be premixed before extrusion and treated in a way to arrest the reaction between the coreactive components, such as by freezing the composition after mixing.

It may be desirable to select the chemistry of each layer of the deposited hardenable composition such that covalent bonds between successive layers are formed. Different portions of the article can be printed from different hardenable compositions (e.g., a first hardenable composition printed to form a first portion of the object such as a base portion, an internal structure, etc., and a second hardenable composition printed to form a second portion of the object); depending on the chemical reactivity between the different hardenable compositions, covalent bonds might also form between different materials.

An article may be printed so as to have a rigid portion (unable to bend without breaking) and a flexible portion (does not break when initially bent), a rigid portion and a foam-like portion (hardenable composition includes voids), a tactile portion (textured) and a rigid and/or flexible portion, two or more portions that include different densities, one or more conductive portions, one or more thermally/electrically conductive (allows heat or electricity to travel through) portions, two or more different colors, two or more different rheological profiles, two or more different materials that include different affinities for water and/or solvent(s), and the like. The article may also be printed such that the hardenable compositions are deposited onto existing articles (e.g., other thermosets and/or thermoplastics, metals, woods, composite materials, ceramics, etc.).

Ambient manufacturing as described herein may result in an object having higher strength, particularly along the Z (e.g., vertical) axis, as compared to other extruded or printed parts due to the covalent bonding between the printed layers. Strong intralayer and interlayer covalent bonding results in not only stronger parts, but also in more uniform part geometries; that is, less print lines and/or portion differentials. The present disclosure therefore provides the ability to form, in one process, objects having multiple substrates and/or portions that include different compositions.

Table 1 describes suitable hardenable compositions and the coreactive components from which they can be formed. These hardenable compositions can be printed by any of the methods described herein, either alone or in combination, to form three dimensional objects.

TABLE 1
Hardenable Compositions

| Hardenable | First Coreactive Component | Second Coreactive Component (e.g., |
|---|---|---|
| Composition | (e.g., Reactant Group A) | Reactant Group B) |
| Polyurea-based | A polyisocyanate-containing | An amine-containing compound, such |
| hardenable | compound, such as polyisocynate | as a polyamine including polyamine |
| composition | prepolymer(s), polyisocynate | prepolymer(s), polyamine monomer(s), |
| | monomer(s), difunctional | difunctional polyaminc prepolymer(s), |
| | polyisocyanate prepolymer(s), | trifunctional polyetheramine(s) or |
| | isocyanate-terminated | blends thereof. |
| | polytetramethylene prepolymer(s), | |
| | isocyanate-terminated | |
| | polytetramethylene prepolymer(s), | |
| | isophorone-terminated | |
| | polytetramethylene prepolymer(s) or | |
| | blends thereof. | |
| Polythioether-based | An epoxy-containing compound, such | A thiol-containing compound, such as |
| hardenable | as polyepoxide prepolymer(s), | polythiol prepolymer(s), polythiol |
| composition | polyepoxide monomer(s) or blends | monomer(s), or blends thereof. |
| | thereof. | |
| Michael addition- | A Michael donor compound, such as | A Michael acceptor compound |
| based hardenable | prepolymers and/or monomers of a | including alpha and/or beta- |
| composition | thiol-containing compound, an amine- | unsaturated compounds and electron |
| | containing compound, and/or a | withdrawing substituents, such as |
| | carbanion-containing compound. | prepolymers, monomers, or |
| | Michael donor compound can include | combinations thereof, of any one of |
| | as an amine, thiol, enolate, alcohol, or | alpha and/or beta-unsaturated |
| | enamine group or combinations thereof. | aldehydes, alpha and/or beta- |
| | | unsaturated molecules such as |
| | | acrylates, maleates, fumarates, and/or |
| | | methacrylates, vinyl ester-containing |
| | | compounds, vinyl sulfone-containing |
| | | compounds, imidazole-containing |
| | | compounds, and maleimide-containing |
| | | compounds. |
| Aza-Michael | A Michael donor compound such as | A Michael-acceptor compound |
| addition-based | prepolymers and/or monomers of a | including an alkene-containing |
| hardenable | amine-containing compound, such as a | compound, such as prepolymers, |
| composition | polyamine prepolymer(s), polyamine | monomers, or combinations thereof, of |
| | monomer(s), or blends thereof. | any one of alpha and/or beta- |
| | | unsaturated aldehydes, alpha and/or |
| | | beta-unsaturated ketones or esters such |
| | | as acrylates, maleates, fumarates, |
| | | and/or methacrylates, vinyl ester- |
| | | containing compounds, vinyl sulfone- |
| | | containing compounds, imidazole- |
| | | containing compounds, and |
| | | maleimide-containing compounds. |
| Thia-Michael | A Michael donor compound such as | A Michael-acceptor compound |
| addition-based | prepolymers and/or monomers of a | including an alkene-containing |
| hardenable | thiol-containing compound, such as | compound, such as prepolymers, |
| composition | polythiol prepolymer(s), polythiol | monomers, or combinations thereof of |
| | monomer(s), or blends thereof. | any one of alpha and/or beta- |
| | | unsaturated aldehydes, alpha and/or |
| | | beta-unsaturated ketones or esters such |
| | | as acrylates, maleates, fumarates, |
| | | and/or methacrylates, vinyl ester- |
| | | containing compounds, vinyl sulfone- |
| | | containing compounds, imidazole- |
| | | containing compounds, and |
| | | maleimide-containing compounds. |
| Polyurethane-based | A hydroxyl-containing compound, such | An isocyanate-containing compound, |
| hardenable | as polyol prepolymer(s), polyol | such as polyisocyanate prepolymer(s), |
| composition | monomer(s), or blends thereof. | isocyanate monomer(s), or blends |
| | | thereof. |
| Epoxy-amine-based | An epoxy-containing compound, such | An amine-containing compound, such |
| hardenable | as polyepoxide prepolymer(s), | as polyamine prepolymer(s), |
| composition | polyepoxide monomer(s), or blends | polyamine monomer(s), ketamine |
| | thereof. | prepolymer(s), ketamine monomer, or |
| | | blends thereof, and/or an amide- |
| | | containing compound, such as |
| | | polyamide prepolymer(s), polyamide |
| | | monomer(s), or blends thereof. |
| Epoxy-anhydride- | An epoxy-containing compound, such | An anhydride-containing compound, |
| based hardenable | as polyepoxide prepolymer(s), | such as anhydride prepolymer(s), |
| composition | polyepoxide monomer(s), or blends | anhydride monomer(s), or blends |
| | thereof. | thereof. |
| Thiolene-based | A thiol-containing compound, such as | An alkylene-containing compound, |
| hardenable | polythiol prepolymer(s), polythiol | such as polyalkene prepolymer(s), |
| composition | monomer(s), or blends thereof. | polyalkene monomer(s), or blends |
| | | thereof. |
| Polysulfide-based | A catalyst and/or activator, such as an | A thiol-containing compound, such as |
| hardenable | oxidizing compound, such as | polythiol prepolymer(s), polythiol |
| composition | metalperoxides, metal oxy-salts, and/or | monomer(s), or blends thereof. |
| | other oxidizing agents, or blends | |
| | thereof. | |
| Condensation | An amine-containing compound, such | An acetate-containing compound, such |
| reaction-based | as a polyamine prepolymer(s), | as polyacetoacetate prepolymer(s), |
| hardenable | polyamine monomer(s), or blends | polyacetoacetate monomer(s), or |
| composition | thereof. | blends thereof. |

Numerous entries in Table 1 include amine-containing compounds. The amine-containing compounds can include those available under the trade name DESMOPHEN, commercially available from Covestro LLC.

Numerous entries in Table 1 include polyisocyanate containing compounds. The polyisocyanate containing compounds can include those available under the trade name DESMODUR, commercially available from Covestro LLC.

Hardenable compositions according to the present disclosure may be three dimensionally printed at relatively low viscosity (less than 1,000,000 cps). “Viscosity” refers to a value determined at 23° C. and ambient pressure and reflects a fluid's resistance to flow when subjected to a shear stress and/or a shear strain; viscosity as reported herein is measured using a Brookfield Viscometer (AMETEK.Inc.) using spindle No. 7 at 50 rpm. Therefore, relatively large amounts (e.g., high relative weight percentages, such as, without limitation, 5 weight percent based on the total weight of the hardenable composition)) of additives and/or fillers can be included with the hardenable components while maintaining a printable viscosity (less than 1,000,000 cps). Both the type and/or the amount of additives can be selected or “tuned” to result in desirable chemical and/or physical properties of the printed article. Hardenable compositions can be tuned with the addition of additives and/or fillers for desired mechanical performance (e.g., strength, elasticity, rigidity, sag resistance, etc.), surface features (e.g., hardness, texturing, smoothness, etc.), chemical resistance (e.g., solvent resistance, etc.), thermal resistance (including fire retardancy, etc.) or conductivity, and/or electrical insulation or conductivity. Hardenable compositions can also be tuned with the addition of one or more catalytic/activator/accelerant additives in any of the hardenable components to result in desirable reaction kinetics, such as rate of reaction.

Table 2 describes additives that can be included with any hardenable composition according to the present disclosure, such as those described in Table 1. The additives can be included in either or both of the first and second coreactive components depending on the desired chemical and/or physical properties of the resulting object. Table 2 describes specific additives and fillers that may be suitable for ambient reactive extrusion-based three-dimensional printing, however, Table 2 is non-limiting. Therefore, other additives may be included with the hardenable composition(s), such as additives known to those skilled in the coatings, extrusion, and thermoplastic areas.

TABLE 2
Additives/Fillers

| Function | Additive Categories |
|---|---|
| Catalysts | Oxidative catalysts, latent catalysts, basic catalysts, acidic |
| | catalyst, Lewis acidic catalysts, Lewis basic catalysts. |
| Activators | Inorganic activators, organic activators. |
| Accelerants | Triazine-based accelerants, thiazole-based accelerants, |
| | sulfide-based accelerants. |
| Pigments | Effect Pigments (e.g., additives that may affect |
| | appearance and/or performance), colorants, dyes. As used |
| | herein, the term “colorant” refers to any substance that |
| | imparts color and/or other opacity and/or other visual |
| | effect to a coating composition and can include, without |
| | limitation, dyes, pigments and/or particles. As used |
| | herein, the term “dye” refers to a colored substance, in |
| | many cases an organic compound, that can impart color to |
| | a composition. |
| Rheology Modifiers | Natural polymers, synthetic polymers, inorganic |
| | materials, thermoplastics, thermosets. |
| Organic/Inorganic fillers | Clay-based fillers, talc-based fillers, silicas glass powders, |
| | mica-based fillers, diatomaceous earth-based fillers, |
| | calcium carbonate-based fillers. |
| Fire retardant fillers | Inorganic fire retardants, organic fire retardants. |
| Low-density fillers (density less | Microcapsules, microspheres, microballoons, glass beads. |
| than 1 g/cc) | |
| Conductive fillers | Thermally conductive fillers, electrically conductive |
| | fillers, magnetic fillers, EMI/RFI shielding fillers. |
| Adhesion promoters | Phenolic-based adhesion promoter, silane-based adhesion |
| | promoter. |
| Plasticizers | Phthalates, phenyls, benzoates, waxes, oils, non-reactive |
| | polymers. |
| Leveling additives | Silicone-based leveling agents, acrylate-based leveling |
| | agents, fluorocarbon-based leveling agents, hydrocarbon- |
| | based leveling agents. |
| Defoaming/Deacrating agents | Oil-based defoaming agents, powder-based defoaming |
| | agents, water-based defoaming agents, silicone-based |
| | defoaming agents, and alkyl polyacrylate-based |
| | defoaming agents. |
| Surfactants | Anionic-based surfactants (e.g., sulfate, sulfonate, |
| | phosphate, carboxylate derivatives, etc.), cationic head |
| | group-based surfactants, amphoteric-based surfactants, |
| | non-ionic based surfactants. |
| Drying agents | Primary (e.g., active) drying agents, secondary (e.g., |
| | auxiliary) drying agents. |
| Dispersants | Polymeric dispersing agents, ionic dispersants, non-ionic |
| | dispersants, polyester-based dispersants, polyamide-based |
| | dispersants, polyglycol-based dispersants, fatty acid-based |
| | dispersants, polyether-based dispersants, polyurethane- |
| | based dispersants, polyacrylate-based dispersants. |
| Wetting agents | Silicone-based wetting agents, silicone free wetting agents |
| | (e.g., acetylenic, alkoxylate derivates, etc.), hydrocarbon |
| | based wetting agents, |
| | polymeric silicone free based wetting agent (e.g., |
| | acrylates, maleates derivatives, etc.), fluor-based wetting |
| | agents, organic-based wetting agents. |
| Light-stabilizing agents | Hindered amine-based compounds, UV absorber |
| | compounds, Quencher compounds. |
| Emulsifiers | Cationic-based emulsifiers, anionic-based emulsifiers, |
| | non-ionic emulsifiers. |
| Chelating agents | Organic compounds, inorganic compounds |
| Freeze-thaw control agents | Glycol-based compounds, non-ionic compounds, ether- |
| | based compounds. |
| Biocide agents | Heavy metals (e.g., silver), formaldehyde and/or |
| | formalin-based compounds, formaldehyde donor-based |
| | compounds (e.g., triazines), organosulfur-based |
| | compounds, isothiazoline-based compounds, pyridine |
| | derivative- based compounds, organic acid and/or salt- |
| | based compounds, nitrogen-based compounds, phenolic- |
| | based compounds. |
| Heat stabilizing agents | Organotin-based heat stabilizers, alkyltin intermediates, |
| | organic compounds, organometallic compounds, metallic |
| | soaps. |
| Corrosion inhibiters | Zinc phosphate-based corrosion inhibitors, Lithium- |
| | phosphate-based corrosion inhibitors, chromate-based |
| | corrosion inhibitors. |
| Moisture scavengers | zeolite, alumina, silica, calcium oxide, magnesium oxide, |
| | molecular sieve, anhydrous sodium sulphate, anhydrous |
| | magnesium sulphate, alkoxysilanes. |
| Intumescent materials | Melamine-based materials, ammonium polyphosphate- |
| | based materials, and expandable graphite-based materials. |
| Thermally conductive, | A pigment and/or a particle, filler, or inorganic powder |
| electrically insulative materials | that has a thermal conductivity of at least 5 W/m · K at |
| | 25° C. (measured according to ASTM D7984) and a |
| | volume resistivity of at least 10 Ω · m (measured according |
| | to ASTM D257, C611, or B193). |
| Thermally conductive, | A pigment and/or a particle, filler, or inorganic powder |
| electrically conductive materials | that has a thermal conductivity of at least 5 W/m · K at |
| | 25° C. (measured according to ASTM D7984) and a |
| | volume resistivity of less than 10 Ω · m (measured |
| | according to ASTM D257, C611, or B193). |
| Non-thermally conductive, | A pigment and/or a particle, filler, or inorganic powder |
| electrically insulative materials | that that has a thermal conductivity of less than 5 W/m · K |
| | at 25° C. (measured according to ASTM D7984) and a |
| | volume resistivity of at least 10 Ω · m (measured according |
| | to ASTM D257, C611, or B193). |

Various additives and fillers are outlined in Table 2, such as, without limitation, fumed silicas such as those available under the trade name CABOSIL, commercially available from Cabot Corporation; hindered amine light stabilizers such as those available under the trade name TINUVIN, commercially available from BASF SE; UV light absorbers such as those available under the trade name CYASORB, commercially available from CYTEC Industries Inc.

Any suitable combination of coreactive composition(s) and optionally additive(s)/filler(s), can be printed by a three-dimensional printing system adapted for mixing and extruding feedstocks. Two or more volumetric metering pumps (e.g., positive displacement pumps, progressive cavity pumps, etc.) may each respectively discharge, in combination or succession, the two coreactive components associated with a hardenable composition (e.g., the first coreactive component discharged by the first metering pump and the second coreactive component discharged by the second metering pump into a mixing volume). In some cases, the mixing volume can include mechanical (e.g., driven) mixing features. Upon entering the mixing volume, the first and second hardenable components begin to mix and react, and thereafter, arc extruded through an extrusion print nozzle in an at least partially reacted state. Once extruded, the two coreactive components further react and cure or harden.

Two or more layers of the hardenable composition can be applied prior to a pigment component being applied to a surface of the hardenable composition. The one or more initial or first layer(s) can have a sufficiently high viscosity and/or gel such that the first layer(s), once applied, do not move appreciably and can be used to provide a surface to which a lower viscosity second hardenable composition can be applied. In this instance, the pigments and/or particles in the pigment composition can more readily embed into the lower viscosity second hardenable composition, which is held in place by the higher viscosity and/or gelled initial first layer(s).

The first hardenable composition making up the first layer(s) can include a higher amount of rheology modifier and/or filler compared to the second hardenable composition making up the second layer(s). The first hardenable composition can include from 1 wt. % to 15 wt. %, such as from 1.5 wt. % to 10 wt. % or from 2 wt. % to 5 wt. % of rheology modifier and/or filler and the second hardenable composition can include from 0 wt. % to 3 wt. %, such as 0.5 wt. % to 2.5 wt. % or 0.75 wt. % to 2 wt. % of rheology modifier and/or filler, both based on the weight of the respective hardenable composition. The resulting rheology of the first and second hardenable compositions can be, without limitation, from 1 cps to 1,000,000 cps, such as from 250 cps to 500,000 cps, from 300 cps to 100,000 cps or from 500 to 50,000 cps determined using a Brookfield Viscometer (AMETEK.Inc.) using spindle No. 7 at 50 rpm and 23° C. The viscosity of the uncured first hardenable composition may be greater than the viscosity of the second hardenable composition.

The articles of the present disclosure includes a pigment component that can include a pigment and/or a particle. As used herein, the term “pigment component comprising a pigment and/or a particle” refers to a component that is applied to an at least partially unhardened portion of the hardenable composition. The “pigment and/or a particle” in the pigment component is one that imparts a visual and/or performance effect. The pigment and/or a particle in the pigment component is distinguished from pigments, fillers, and other additives that can be included in the coreactive components, such as those listed in Table 2.

Any type of pigment and/or particle can be included in the pigment component. As nonlimiting examples, the pigment and/or particle in the pigment component can include a visual effect pigment that results in a visual effect such as a color effect or color imparting pigment, a metallic pigment, a luminescent pigment, a (retro)reflective pigment and/or particle, a performance effect pigment that results in a particular performance characteristic, such as a radar reflective pigment, a LiDAR reflective pigment, an electrically conductive pigment, a dielectric pigment, a magnetic particle, an EMI/RFI shielding particle and/or other pigments and/or particles imparting a desired characteristic to the article.

Suitable color imparting pigments are well known and include organic and/or inorganic materials, such as titanium dioxide, zinc oxide, iron oxide, carbon black, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), mono azo red, red iron oxide, quinacridone maroon, transparent red oxide, cobalt blue, iron blue, iron oxide yellow, chrome titanate, titanium yellow, nickel titanate yellow, transparent yellow oxide, lead chromate yellow, bismuth vanadium yellow, pre darkened chrome yellow, transparent red oxide chip, iron oxide red, molybdate orange, molybdate orange red, radar reflective pigments, LiDAR reflective pigments, corrosion inhibiting pigments, and combinations thereof.

Metallic pigments can be in any form such as spherical, flake or pellet form, and can include, for example, aluminum, stainless steel, zinc, copper and alloys thereof and flakes thereof, interference pigments, such as titanium dioxide-coated mica, muscovite, phlogopite, or biotite, mica, gold, silver, nickel, platinum, bronze, brass, titanium, tungsten, including oxides and alloys thereof.

Luminescent pigments are commercially available, as are (retro)reflective particles, such as (retro)reflective microspheres. As used herein, (retro)reflective and like terms refers to retroreflective or reflective. “Reflective” pigments or particles are those that reflect light specularly (i.e. at the same angle relative to the normal of the pigment surface, but an angle on the opposite side of the normal relative to the incident direction of the incident light), which can include for example metallic flake pigments, or are those that reflect or scatter light diffusely (in many directions), which can include, for example, titanium dioxide white pigments; “retroreflective” pigments or particles refer to those that return light back to the source and can include, for example, coated glass beads. “Luminescent pigments” are organic or inorganic compounds that absorb and emit energy as visible light when they are relatively cool.

The pigments in the pigment component can include a radar reflective pigment, a LiDAR reflective pigment, an infrared reflective pigment, an electrically conductive pigment, a dielectric pigment, a thermally conductive, electrically insulative material, a thermally conductive, electrically conductive material, a non-thermally conductive, electrically insulative material, a magnetic particle, an EMI/RFI shielding particle and/or other pigments imparting a desired characteristic to the article. The LiDAR, radar reflective, or infrared reflective pigments can include, but are not limited to, nickel manganese ferrite blacks (Pigment Black 30), iron chromite brown-blacks (CI Pigment Green 17, CI Pigment Browns 29 and 35), Pigment Blue 28, Pigment Blue 36, Pigment Green 26, Pigment Green 50, Pigment Brown 33, Pigment Brown 24, Pigment Black 12 and Pigment Yellow 53 and combinations thereof. An “electrically conductive pigment or particle” refers to materials that can serve as a pair of electrodes or current collectors, such as electrically conductive carbon, metals, metal oxides, graphene, or a combination thereof and can be in various forms, such as nanoparticles, microparticles, nanowires, microwires, nanotube, microtubes, or other forms or a combination of such forms; such particles do not necessarily provide color properties but may provide other performance properties. A dielectric pigment refers to optically-variable thin-film pigment flakes that can be prepared either by chemical deposition of dielectric layers onto flaked substrates or by deposition of combinations of transparent dielectric layers, semi-opaque metal layers, and metal reflecting layers onto a flexible web in vacuum to form a multilayered thin film interference structure. A “magnetic pigment or particle” refers to materials having ferromagnetic, ferrimagnetic, superparamagnetic, and/or superferrimagnetic behavior, such as iron, cobalt, and nickel and their oxides and/or alloys such as CoPt, FePt, FeNi, or FeCo AlNiCo, CoPt, FeCoCr and combinations thereof. “EMF/RFI shielding pigments or particles” refers to materials designed to absorb, reflect or conduct electronic noise away from or around sensitive devices and circuits nonlimiting examples of which include aluminum, copper, tin, epoxy and ferrite powders, gold fabric, and nickel.

The pigments in the pigment component can include corrosion inhibiting pigments. Any suitable corrosion inhibiting pigment known in the art can be including, for example, calcium strontium, zinc phosphosilicate; double orthophosphates, in which one of the cations is represented by zinc, nonlimiting examples being Zn—Al, Zn—Ca, Zn—K, Zn—Fe, Zn—Ca—Sr, Ba—Ca, Sr—Ca and combinations thereof; combinations of phosphate anion with anticorrosively efficient anions, nonlimiting examples being silicate, molybdate, and borate; modified phosphate pigments modified by organic corrosion inhibitors and combinations thereof. Nonlimiting examples of modified phosphate pigments include aluminum(III) zinc(II) phosphate, basic zinc phosphate, zinc phosphomolybdate, zinc calcium phosphomolybdate, zinc borophosphate, zinc strontium phosphosilicate, calcium barium phosphosilicate, calcium strontium zinc phosphosilicate, and combinations thereof. Other nonlimiting examples of corrosion inhibiting pigments that can be used in the coating formulation include zinc 5-nitroisophthalate, calcium 5-nitroisophthalate, calcium cyanurate, metal salts of dinonylnaphthalene sulfonic acids, and combinations thereof. Particularly suitable corrosion inhibiting pigments include magnesium oxide such as nano-sized magnesium oxide (5-100 nm, determined by laser diffraction as reported by manufactures, as a nonlimiting example according to ISO 13320-1 (1999)), micron sized magnesium oxide (1-5 microns, determined according to ISO 13320-1 1999)), silica, lithium salts such as lithium nitrate, lithium sulfate, lithium fluoride, lithium bromide, lithium chloride, lithium hydroxide, lithium carbonate, lithium iodide, or combinations of any of these.

The pigment in the pigment component can have a median particle size in the range of 2-75 μm, such as from 2-50 μm, 2-40 μm, 2-30 μm, 2-25 μm, 2-10 μm, 5-75 μm 5-50 μm, 5-40 μm, 5-30 μm, 5-25 μm, or 5-10 μm. Median particle size is measured or reported herein are determined by laser diffraction as reported by manufactures, as a nonlimiting example according to ISO 13320-1 (1999).

The pigments and/or particles in the pigment component can make up from 0.1-100 wt. %, such as 1-90 wt. %, 1-75 wt. %, or 10-70 wt. % of the pigment component, with wt. % based on the total weight of the pigment component. The pigment and/or a particle can make up 100% of the pigment component, such as dry pigment particles. The pigment component can be in the form of a slurry of the pigments and/or particles in a suitable slurry medium. The slurry medium can be selected based on the type of pigment and/or particle used, the type of hardenable composition the pigment component is to be applied to and/or the method of application of the pigment component. The pigment component can also be in the form of a “rinse” or “dip”. Nonlimiting examples of suitable media for forming the slurry or rinse include water; C₃-C₁₂ ketones, such as acetone, methyl ethyl ketone and methyl isobutyl ketone; alcohols, such as isopropanol, butanol and 2-ethyl hexanol; monomethyl, monoethyl and monohexyl ethers of ethylene glycol or propylene glycol, such as propylene gycol methyl ether; C₂-C₁₂ aldehydes, such as acetaldehyde, cinnamaldehyde, and vanillin; esters such as ethyl acetate, butyl acetate, phthalates, sebacates, adipates, terephthalates, dibenzoates, gluterates, or azelates; or any combinations thereof. “Slurry”, “rinse” and “dip” may be used interchangeable herein, as all include pigments and or particles in a carrier; slurry typically refers to a higher solid content than rinse or dip.

When the pigment component includes particles, the particles can include, as nonlimiting examples, beads that can include glass; metal, such as aluminum, stainless steel, and copper; minerals; and/or plastics, such as polyethylene, polypropylene, polyethylene terephthalate, and polyvinyl chloride. The particles are typically larger in size than piments. As an example, when the particles are beads, they can have a mean particle size of from 76 μm to 1,500 μm, such as 80 μm to 1,400 μm, 90 μm to 1,250 μm, or 100 μm to 1000 μm, determined according to ASTM D1214-10 (2020) or AASHTO M247-81 (1996). As another indicator of particle size, when the particles are beads, the particle size can be described as from 80 to 100 wt. % of the beads passing through a size 12 U.S. Mesh screen and/or from 70 to 100 wt. % of the beads passing through a size 14 U.S. Mesh screen and/or from 60 to 95 wt. % of the beads passing through a size 16 U.S. Mesh screen and/or from 5 to 60 wt. % of the beads passing through a size 18 U.S. Mesh screen and/or from 0 to 10 wt. % of the beads passing through a size 20 U.S. Mesh screen, determined according to ASTM D1214-10 (2020) or AASHTO M247-81 (1996).

The pigment and/or particle used in the present pigment component may be one that is typically incompatible for use with ARE. For example, the pigment and/or particle may be too large to pass through the nozzle of the ARE device or may be undesirably reactive with the hardenable composition.

An advantage of the present disclosure is the ability to achieve an effect, such as a visual effect, wherein the amount of pigment and/or particle needed to achieve the effect can be markedly lower than the amount used when blended into the hardenable composition. Not only does this allow for less pigment or particle use, it also may allow for better distribution and/or alignment of the pigment or particle. For example, if the pigment includes a flake pigment, such as an aluminum flake pigment, as a nonlimiting example, those available from Palmer Holland Inc. or Merck KGAA, better orientation of the flake can be achieved; less flake may be used to achieve a better visual effect. As used herein, the terms “flop” or “flop index” refer to the measurement of the change in reflectance of a coated substrate as it is rotated through a range of viewing angles. as measured using a BYK-Mac i Spectrophotometer of BYK Co. A solid color coating or a surface without metallic pigment will typically have a flop index of 0, while a coating that includes metallic or pearlescent pigments will typically have a flop value that can be considered high or low depending on the type of pigment. For example, non-transparent pigments will typically result in coatings having low flop, while coatings with transparent and/or metallic pigments a high flop (15-17). As a nonlimiting example, the hardened articles described herein can have a flop index of greater than or equal to 8, such as greater than or equal to 10 or from 8 to 22, such as from 10 to 20. Flop index is a unitless value.

As noted above, the pigment component is applied to the hardenable composition that is “at least partially unhardened”. The pigment component can be applied when the extent of hardening/curing of the hardenable composition is no more than 75%, such as no more than 65% or no more than 50% or from 0 to 75%, such as 0 to 65% or 0 to 50% of the cure/hardened potential of the hardenable composition as described above. As a result, the pigment and/or particle in the pigment component embeds in the composition upon hardening.

The pigment component can be applied by any means known in the art, such as spraying, rinsing, dipping, vibratory expulsion, screw conveyer, and/or auger. Alternatively, or in conjunction with any of these methods, the pigment component can be applied to the surface of a substrate or mold onto or into which the hardenable composition is applied. In this way, the pigment and/or particle in the pigment component becomes embedded in the hardenable composition as the article is formed and the composition hardens. The pigment component can be applied in a predetermined pattern or shape. For example, the pigment component can be applied, just after application of the hardenable composition, using a motor, such as a stepper motor with a shaft attached to a pigment and/or particle reservoir. The rotational frequency of the motor can be used to control the amount of vibration and, as a result of the vibration, the mass flow rate of particles from the reservoir.

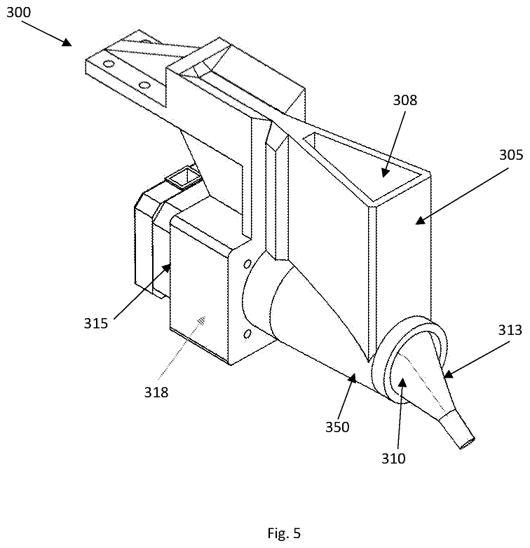

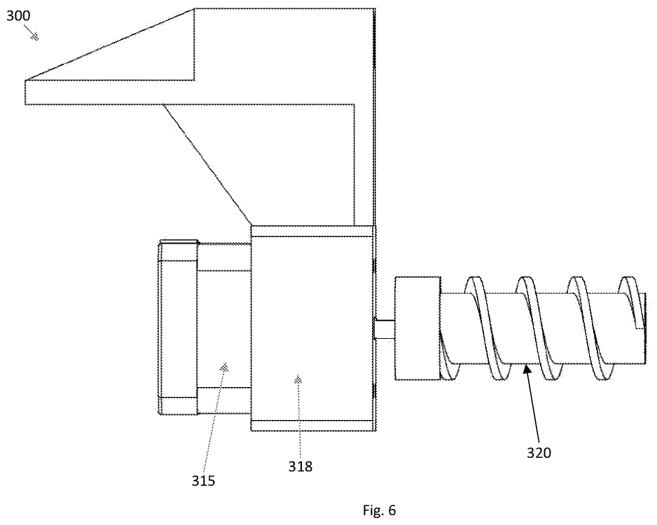

A nonlimiting example of an auger or screw type conveyor that can be used to apply the pigment component according to this disclosure is shown in FIGS. 5, 6 and 7. Screw conveyor 300 includes an auger sleeve 305, auger sleeve opening 308, auger discharge 310, funnel 313, motor 315, such as a stepper motor, motor housing 318, auger housing 350 and auger 320. The pigment component can be fed to auger sleeve 305 via auger sleeve opening 308 and conveyed using auger 320 and expelled via auger discharge 310. In order to control and precisely place the pigment component, funnel 313 can be attached to auger discharge 310 with the narrow end of the funnel situated near the previously applied hardenable composition.

Auger sleeve 305 acts as a hopper with the discharge end being in fluid communication with auger 320. The speed of auger 320 can be controlled by motor 315, which controls the rate that the pigment component is discharged from auger discharge 310. As shown, motor 315 is partially located within motor housing 318 and partially exposed behind motor housing 318.

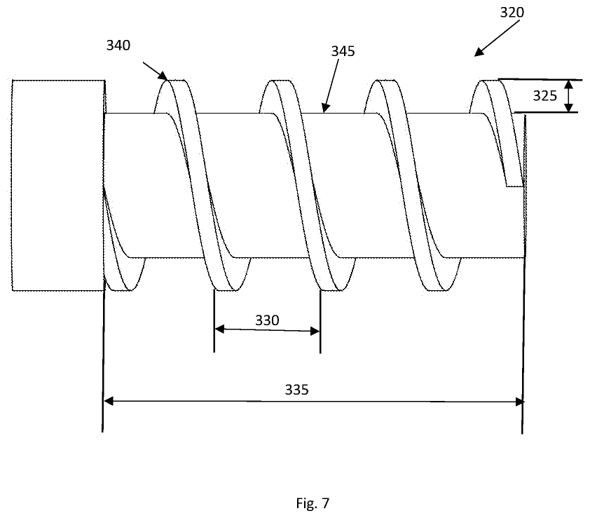

Auger 320, as shown in FIG. 7 (indicated by 335), can be from 2 cm to 15 cm long, such as 3 cm to 14 cm long or 4 cm to 13 cm long. Auger 320 includes flights 340, which spiral around shaft 345 of auger 320. The turning motion of auger 320, effectuated by motor 315, allows flights 340 to transport the pigment component from the discharge from auger sleeve 305 to auger discharge 310.

Depending on the nature of the pigment component, flights 340 of auger 320 are spaced apart (indicated by 330) and can have a width 325, which can extend from auger shaft 345 to an inner wall of auger housing 350 (FIG. 5). Width 325 of auger 320 can be from 0.2 cm to 2.5 cm, such as from 0.25 cm to 2 cm or from 0.3 cm to 1.5 cm. Width 325 can vary depending based on the nature of the pigment component, such as the particle size of the pigments and/or particles contained therein and the desired feed rate. Spacing 330 of auger flights 340 can be from 0.5 cm to 4 cm, such as from 0.75 to 3.5 cm or from 1 cm to 3 cm. Spacing 330 can vary depending based on the nature of the pigment component, such as the particle size of the pigments and/or particles contained therein and the desired feed rate. The feed rate of the pigment component from screw conveyer 300 to the surface of the hardenable composition can also be controlled by the rate of rotation of auger 320 by motor 315. The rate of rotation of auger 320 can be from 1 rpm to 180 rpm, such as from 25 rpm to 150 rpm, or from 50 rpm to 125 rpm. The rate of rotation of auger 320 can vary depending based on the nature of the pigment component, such as the particle size of the pigments and/or particles contained therein and the desired feed rate.

Particularly suitable for use with the present articles are those imparting a visual effect to the article of manufacture. It will be appreciated that coating or painting articles made by ARE can be challenging. Directly embedding the pigment and/or particle in a surface of the hardenable composition that forms the article avoids these challenges and can result in a high-quality finish. Similarly, embedding a performance pigment and/or particle to the surface of the article can result in improved performance, such as electrical conductivity, as compared to when such a pigment and/or particle is dispersed throughout the hardenable composition. The pigment and/or particle of the pigment composition become embedded in the article and there is no need for a topcoat to keep the pigments and/or particles in place. While a topcoat or other layer can be applied, the use of such a layer(s) can be specifically excluded according to the disclosure.

The hardenable composition can be applied with a texture that aids in orienting the pigment and/or particle to provide greater reflectivity or retroreflectivity. The texture can include divots and/or “peaks and valleys”, where the difference in height between a peak and valley aids in orienting the pigment and/or particle.

Also, a first hardenable composition, as described above, can be applied to form a “checkerboard” type surface. A second hardenable composition as described above, can be applied to a surface of the first hardenable composition on to which the pigment component can be applied. The rheology of the uncured first hardenable composition allows for the first hardenable composition to stay in place and the rheology of the uncured second hardenable composition allows for the pigments and/or particles in the pigment component to embed in the second hardenable composition prior to curing or hardening.

According to the present disclosure, the articles described herein can form all or part of an article of manufacture. Particular examples include a structure, a vehicle, an industrial protective structure such as an electrical box enclosure, transformer housing, or motor control enclosure; a railcar container, tunnel, oil or gas industry component such as platforms, pipes, tanks, vessels, and their supports, marine component, automotive body part, aerospace component, pipeline, storage tank, pavement, road marking or wind turbine component. “Structure” as used herein refers to a building, bridge, oil rig, oil platform, water tower, power line tower, support structures, wind turbines, walls, piers, docks, levees, dams, shipping containers, trailers, and components of modular housing. “Vehicle” refers to in its broadest sense all types of vehicles, such as but not limited to cars, trucks, buses, tractors, harvesters, heavy duty equipment, vans, golf carts, motorcycles, bicycles, railcars, airplanes, helicopters, boats of all sizes and the like.

The pigment and/or particle of the pigment component can be substantially uniformly distributed on a surface or a portion of a surface of the article and can provide a substantially uniform visual effect to the surface of the article. As used in this context, “substantially” means that the visual effect will be uniform to the naked eye. The visual effect can, for example, be a metallic visual effect, a color effect, a luminous effect, and/or a (retro)reflective effect. The pigment and/or particle can be substantially uniformly distributed on all of the surface (100% of the surface), most of the surface (99-50% of the surface), some of the surface (49-1% of the surface), and/or can be distributed in a predetermined pattern or shape on the surface. The pigments and/or particles may be embedded in the hardened composition such that each pigment and/or particle is surrounded by the composition and therefore insulated from each other. Alternatively, the pigments and/or particles may be in contact with each other. This might be of particular interest, for example, if electrical conductivity is desired.

The pigment component and/or the hardened article may be substantially free (less than 5 weight percent based on the total weight of the article), essentially free (less than 1 weight percent based on the total weight of the article) and/or completely free (undetectable) of abrasion resistant particles, electrically conductive particles, reinforcing particles and/or magnetic particles and, when the film-forming component is free of thermoplastic, (retro)reflective particles and/or luminescent particles.

As used herein, the term “abrasion resistant particle” refers to particulates that impart wear and scratch resistance and can include, as nonlimiting examples, diamond; crystalline materials, such as polycrystalline materials, monocrystalline materials, or a combination thereof; amorphous materials; ceramic materials; glass-ceramic materials; superabrasive materials; minerals; carbon-based materials; or any combination thereof; these particles may or may not provide additional properties. As used herein, “reinforcing particles” and like terms refer to particles that impart structural integrity, such as stiffness or strength, to a composition. Such particles can have many different shapes such as spherical, semi spherical, flake, rod, whisker and the like, and can include, for example, fiberglass and glass beads.

A three-dimensional article according to the present disclosure can be produced by forming successive portions or layers of an article by depositing at least two coreactive components onto a substrate and thereafter depositing additional portions or layers of the hardenable composition over the underlying deposited portion or layer. Layers are successively deposited to build a printed article. The hardenable components can be mixed and then deposited or can be deposited separately. When deposited separately, the components can be deposited simultaneously, sequentially, or both simultaneously and sequentially.

The hardenable composition can be hardened or cured by any suitable method, such as heat curing, radiation curing, or by reaction at ambient or elevated temperatures (such as, without limitation, greater than or equal to 80° C.).

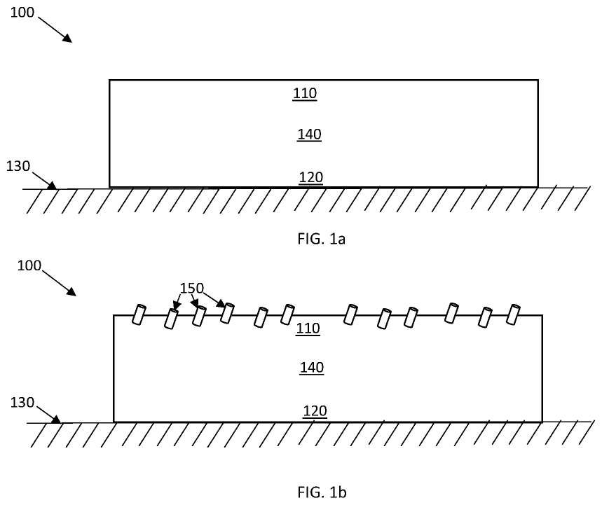

FIGS. 1a and 1b depicts a cross-section of an article of manufacture according to this disclosure. FIG. 1a shows a hardenable composition 100 deposited on a surface 130 and includes an outer surface section 110, a surface deposited section 120 and an internal section 140 prior to embedding pigments and/or particles. As shown in FIG. 1b, pigments and/or particles 150 are partially embedded in outer surface section 110. This can be achieved, for example, by applying pigments and/or particles 150 after hardenable composition 100 has been applied to surface 130, but not yet completely hardened or cured as described herein.

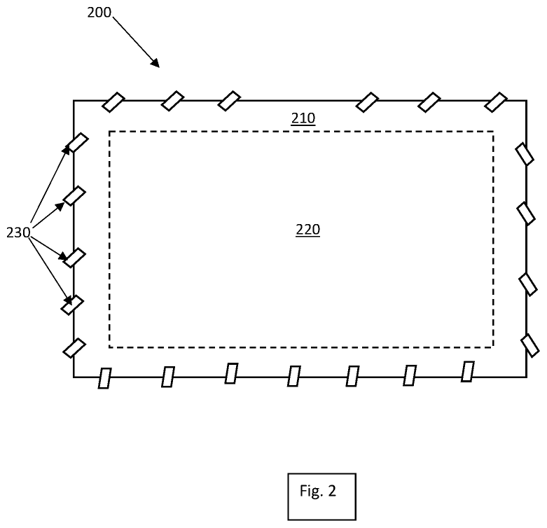

FIG. 2 depicts a cross-section of an article of manufacture according to this disclosure. Article 200 includes an outer surface 210 and core 220. Surface 210 as shown makes up approximately 20% of volume of the article. Pigment and/or particle 230 from the pigment component is embedded in outer surface 210. As noted above the pigments and/or particles can be partially and/or completely embedded, although shown only in FIG. 2 as being partially embedded; that is, the pigment and/or particle embedment can be from 10 vol. % to 100 vol. %, such as from 20 vol. % to 100 vol. %, or 50 vol. % to 100 vol. % or 70 vol. % to 100 vol. %, based on the total volume of the particles as determined by cross-section microscopy. Moreover, while pigment and/or particle embedment is shown in FIG. 2 applied to all four exterior surfaces, pigment and/or particle can be embedded in less than all of the surface, such as only one side of the article 220 or a portion of one side.

Referring to FIGS. 1b and 2, the pigments and/or the particles can be concentrated in at least 0.1 wt. %, such as at least 1 wt. %, at least 5 wt. % and can be up to 75 wt. % or greater, such as 80 wt. % or greater, 85 wt. % or greater, 90 wt. % or greater, or 95 wt. % or greater of a surface of the article. Also, the pigments and/or the particles can be concentrated in at least 0.01 vol. %, such as at least 0.1 vol. %, at least 1 vol. % or at least 5 vol. % and can be up to at least 25 vol. %, such as at least 15 vol. %, or at least 10 vol. % of a portion of the article based on the total volume of the article; such as outer section 110 in FIG. 1b and surface 210 in FIG. 2.

It is to be understood that this disclosure may assume various alternative variations and step sequences, except where expressly specified to the contrary. Accordingly, unless indicated to the contrary, the numerical parameters set forth herein are approximations that can vary depending upon the desired properties to be obtained. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the disclosure may be approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10. Similarly, “a range of from 0.06 to 0.25 wt. %, or from 0.06 to 0.08 wt. %” would include each of from 0.06 to 0.25 wt. %, from 0.06 to 0.08 wt. %, and from 0.08 to 0.25 wt. %.

Unless otherwise stated, plural encompasses singular and vice versa. As used herein, the term “including”, “such as”, “for example” and like terms means “including but not limited to”, “such as but not limited to”, “for example, but not limited to”. Similarly, as used herein, the terms “on”, “applied on/over”, “formed on/over”, “deposited on/over”, “overlay” and “provided on/over” mean formed, overlay, deposited, or provided on but not necessarily in contact with the surface. For example, an article “formed over” a substrate does not preclude the presence of one or more other articles of the same or different composition located between the formed article and the substrate.

As used herein, the articles “a”, “an”, and “the” include plural references unless expressly and unequivocally limited to one referent and shall be construed to include “at least one” and “one or more”. Therefore, reference to “an” article, “a” pigment and/or particle and the like refers to one or more of any of these items.

Unless otherwise indicated, ambient conditions of temperature and pressure are ambient temperature (20-25° C.) and standard pressure of 101.3 kPa (1 atm).

As used herein, the terms “auger conveyor” and “screw conveyor” refer to a mechanism that uses a rotating helical screw blade, which can be located within a tube, to transport the pigment component to a surface of the hardenable composition.

As used herein, the transitional term “comprising” (and other comparable terms, e.g., “containing” and “including”) is “open-ended” and open to the inclusion of unspecified matter. Although described in terms of “comprising”, the terms “consisting essentially of” and “consisting of” are also within the scope of the disclosure. As used herein, “consisting essentially of” means the specified materials or steps listed as well as those that do not materially affect the basic characteristics disclosed; “consisting of” means only the specified materials or steps.

As used herein, the terms “crosslinking agent”, “crosslinker”, “curing agent”, “hardener” and the like refer to a molecule or polymer containing a functional group reactive with a functional group of the polymers and/or resins in the hardenable composition.

As used herein the prefix “poly” refers to two or more. As a nonlimiting example, a polyisocyanate refers to a compound that includes two or more isocyanate groups and a polyol refers to a compound that includes two or more hydroxyl groups.

As used herein, the term “polyisocyanate” refers to blocked (or capped) polyisocyanates as well as unblocked polyisocyanates.

As used herein, the term “polymer” includes homopolymers (formed from one monomer) and copolymers that are formed from two or more different monomer reactants or that include two or more distinct repeat units. Further, the term “polymer” includes prepolymers, and oligomers. “Polymer” and “resin” may be used interchangeable herein.

As used herein “multi component”, which can be “two component” or “2K”, and like terms refer to a composition that includes a first component that contains a functional material and at least one other component that contains functional material reactive with that in the first component. Typically, the components are maintained separately until just prior to use and react when combined.

As used herein, the term “reflective” and similar terms refer to pigments and particles that send incident radiation, as a nonlimiting example, light, away from the pigment or particle in different direction than the angle of entrance of the radiation. As a nonlimiting example, a mirror is considered to be reflective.

As used herein, the term “retroreflective” and similar terms refer to pigments and particles that send incident radiation, as a nonlimiting example, light, away from the pigment or particle in the same direction of the angle of entrance of the radiation. As nonlimiting examples, glass beads and prisms are considered to be retroreflective.

As used herein, the term “(retro)reflective” and similar terms refer to either or both reflective and retroreflective.

As used herein, the term “vibratory expulsion” refers to applying pigments and/or particles by relying on vibration to cause the pigments and/or particles to flow from a reservoir to a hardenable composition, such as using the rotational frequency of a motor to modulate the amount of vibration resulting in the flow of pigments and/or particles from a reservoir.

As used herein, the term “visual effect”, unless otherwise stated, refers to a color, a metallic appearance, a luminescent appearance, sparkle appearance, Flop Index, and/or a (retro)reflective effect imparted by a pigment, dye and/or particle and the like when embedded in a surface of an article of manufacture.

### EXAMPLES

The following examples are intended to illustrate the invention and should not be construed as limiting the invention in any way.

### Example 1—Polyurea Surface Embedded with Effect Pigments

In this example, a 3D printable, 2K polyurea formulation was printed and effect pigments were embedded to the surface. Color evaluation was performed using a BYK-Mac I metallic color spectrophotometer instrument manufactured by BYK-Gradner. The BYK-Mac spectrophotometer was used to measure Flop Index, color, and sparkle properties. SEM micrographs were collected to determine the orientation of the embedded particles. The 2K formulation included a first component that included a diamine and a second component that included an aliphatic polyisocyanate.

The components of the first, di-amine component, were weighed into a Max 300 L DAC cup from Flacktek. The formulation was dispersed via a typical Speedmixer procedure.

The components of the second, aliphatic polyisocyanate component, were weighed into a Max 300 L DAC cup from Flacktek. The formulation was dispersed via a typical Speedmixer procedure.

The two components were transferred from the DAC cups to an Optimum cartridge via Flacktek SpeedDisc to be suitable for 3D printing by ambient reactive extrusion via Viscotec 2k extruders mounted to a gantry. The first component and the second component were printed at a volume mix ratio of 1.2:1.

Thin samples at the size of 3″×5″×0.078″ were printed from the formulation onto a Powercron 8000 panel (ACT part no. 44049). The print settings were a flow rate of 3 mL/min, bead width and height of 1 mm, 100% rectilinear infill, one perimeter, a speed of F2400 at 100% feed rate, and a 90 psi of nitrogen on the material supply tubes. An effect pigment was embedded into the 3D printed polyurea via spray applications after printing the sample material. Samples were baked at 160° F. for 2 days post particle embedment.

The procedure to embed the particles by spraying solvent slurries or electrostatically spraying powder are summarized below, along with a summary of relevant data, in Table 3. The slurries were applied with spray conditions as follows: gun-3M Accuspray, 1.2 mm nozzle, 40 psi backpressure, 21.1° C., and 51.7% relative humidity. The powder was sprayed electrostatically by adding the powder to a cup and then electrostatically applied (via Encore LT Manual electrostatic spray gun) to the part using 75 kV at a flow rate of 30 psi and atomization of 30 psi.

TABLE 3
Effect pigments embedded into the surface of the 3D printed
polyurea article and its application conditions

| | | | Time of |
|---|---|---|---|
| Sample | | Application | Application |
| Number | Effect Pigment/Solvent | method | afterprint |
| 1 | None | Control | N/A |
| 2 | 15 g ¹ Aluminum Flake in | spray gun | 10 min after |
| | 150 g methyl ethyl ketone | Solvent slurry via | print finish |
| 3 | 15 g Aluminum Flake in | paint spray gun | 10 min after |
| | 150 g Propylene glycol | Solvent slurry via | print finish |
| | methyl ether acetate | paint | |
| 4 | ² Xirallic Galaxy Blue | 1 pass Powder | 10 min after |
| | | spray | print finish |

¹ TCR 3040, commercially available through Palmer Holland Inc
² T60-23 SW, commercially available through Merck KGaA

The cured samples were imaged using a digital camera. Color change resulting from effect pigment incorporation was observed as a silver (Samples 2 and 3) or blue (Sample 4) color compared to Sample 1, which had no pigment.

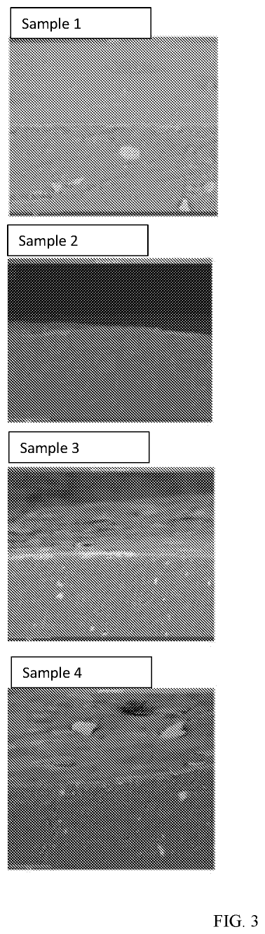

The cured samples were imaged using a Scanning Electron Microscopy (SEM) along with energy dispersive X-ray spectroscopy (EDX). In FIG. 3, the flake can be seen to be concentrated at the surface to maximize its visual effect. Corresponding EDX images confirmed the location of the pigment. The flop index of the polyurea articles was measured using the BYK-Mac i Spectrophotometer of BYK Co. Specifically, the flop index was calculated by measuring the luminance (L*) of reflected light at angles of 15°, 45°, and 110° with respect to the surface of the printed article, and then substituting these values into Equation 1:

$$Flop Index = \frac{2.69 {( {L}_{15 °}^{*} - {L}_{110 °}^{*} )}^{1.11}}{{( {L}_{45 °}^{*} )}^{0.86}} \qquad Equation 1$$

where
L*_{15°}=luminance of the reflected light measured at an angle of 15°
L*_{45°}=luminance of the reflected light measured at an angle of 45°
L*_{110°}=luminance of the reflected light measured at an angle of 110°
The flop index of the object surface without metallic particles was zero.

In the corresponding BYK Mac data, a desirable high degree of travel is observed in the silvers in the L* values, indicating a highly oriented flake. In the case of the xirallic pigment, travel is seen in the L* and the blue value due to the fact that flake itself adds a blue color.

TABLE 6
Color values measured at various angles

| Panel | Flop | L*−15 | L* 15 | L* 25 | L* 45 | L* 75 | L* 110 | b*−15 | b* 15 | b* 25 | b* 45 | b* 75 | b* 110 |
|---|---|---|---|---|---|---|---|---|---|---|---|---|---|
| Ex. 1 | 4.21 | 73.81 | 56.63 | 34.55 | 30.80 | 32.92 | 35.30 | −4.24 | −7.16 | −10.23 | −11.82 | −11.51 | −11.49 |
| Ex. 2 | 17.76 | 154.95 | 135.74 | 102.52 | 50.12 | 29.44 | 28.22 | −0.30 | 0.08 | −0.06 | −1.38 | −2.38 | −2.53 |
| Ex. 3 | 18.58 | 144.74 | 143.66 | 103.29 | 49.77 | 28.11 | 25.92 | −0.09 | −0.45 | −0.46 | −1.41 | −2.69 | −2.95 |
| Ex. 4 | 7.91 | 85.72 | 81.42 | 56.15 | 36.06 | 35.13 | 38.91 | −31.46 | −38.96 | −26.50 | −10.85 | −7.13 | −6.76 |

For Examples 2-4, the pigment appeared to penetrate the unhardened polyurea and align as needed to get the desired appearance. The addition of solvent appears to enable the 3D printed resin to thermodynamically enable preferential pigment alignment; the time of embedment relative to the gel time played less of a role.

### Example 2—Polyurea Surface Embedded with Glass Beads

In this example, a 2K polyurea formulation was printed using ambient reactive extrusion (ARE) manufacturing and a solid effect particle, namely glass beads, was embedded into the unhardened composition. Macroscope images were used to verify the extent of bead embedment into the material. DELTA LTL-X Mark II (DELTA—a part of FORCE Technology) measurements were made to characterize retroreflectivity of the sample.

A 2K formulation included a first component that included a diamine and a second component that included an aliphatic polyisocyanate. The components of the first component, were weighed into a Max 300 L DAC cup from Flacktek. The formulation was dispersed via a typical Speedmixer procedure. The components of the second component were weighed into a Max 300 L DAC cup from Flacktek. The formulation was dispersed via a typical Speedmixer procedure.

The second component and the first component were printed at a volume ratio of 2:1 and fed through a static mixing nozzle.

A reservoir of Potters Type III glass beads (Potters Industries LLC) was fixed to the extruder. A ⅛″ hole at the bottom of the reservoir led to a ¼″ polyurethane tube, which was guided down the length the extruder and attached to the tip of the static mixing nozzle.

A stepper motor with an off-center weight fixed to the shaft was attached to the glass bead reservoir. The rotational frequency of the motor was controlled to modulate the amount of vibration and, as a result of the vibration, the mass flow rate of glass beads from the reservoir.

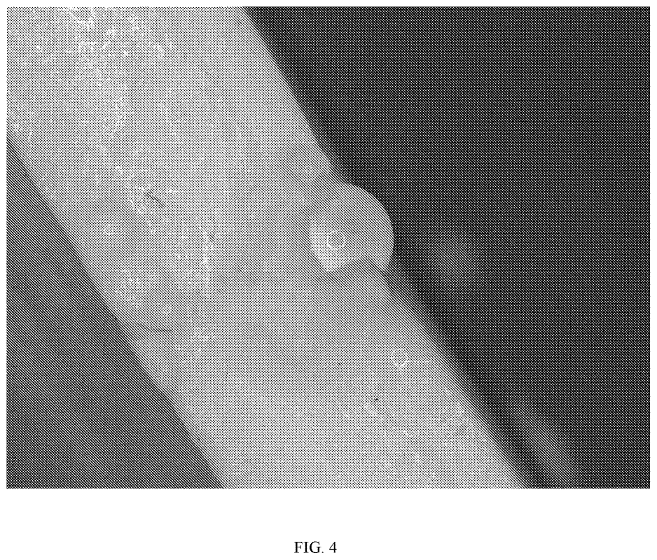

An approximately thin rectangular sample with dimensions 150 mm×700 mm×1 mm was printed with the stepper motor vibrating to induce flow of the glass beads onto the surface of the second component. The glass beads embedded to approximately half of their radius into the printed second component. The glass bead embedment was verified by using macroscope images of a cross section of the printed sample (FIG. 4). Retroreflectivity of the sample, measured using a DELTA LTL-X Mark II, was 250 millicandelas.

### Example 3—Polyurea Surface Embedded with Glass Beads Applied to Pavement

In this prophetic example, the hardenable composition as described in Example 2 is printed directly onto pavement from a truck carrying an extruder (similar to that shown in FIGS. 5-7), a printing axis for linear actuation, and the separate components of the formulation. Glass beads are embedded into the unhardened composition. A DELTA LTL-X Mark II (DELTA—a part of FORCE Technology) instrument can be used to characterize retroreflectivity of the sample.

Amine and isocyanate components used in standard polyurea formulations are prepared and transferred to a ViscoMT-XS pail loader (ViscoTec America, Inc.) suitable for 3D printing by ambient reactive extrusion using Viscotec 2k extruders (ViscoTec America, Inc.) mounted to a sliding rail on the back of a truck, 1 cm above the road. The isocyanate composition and amine composition are printed at a volume ratio of 2:1 and fed through a static mixing nozzle.

A reservoir of Potters Type III glass beads (Potters Industries LLC) can be fixed to the extruder. A funnel at the discharge from the extruder can lead to a ¼″ polyurethane tube, which is guided down the length the extruder and attached to the tip of the static mixing nozzle.

The extruder can include a stepper motor with an off-center weight fixed to the shaft and adapted to receive glass beads from the glass bead reservoir. The rotational frequency of the motor is used to control and modulate the amount of vibration and, because of the vibration, the mass flow rate of glass beads from the reservoir.

As the truck moves forward, the extruder moves back and forth at a speed proportional to the truck's speed. The unhardened composition is allowed to seep into the pavement and adhere to it. In parallel, glass beads from the reservoir fall onto the unhardened material and became embedded upon hardening of the composition. Following ambient cure, retroreflectivity of the sample is expected to be 250 millicandelas, determined as described above.

### Example 4—Textured Polyurea Surface Embedded with Glass Beads

In this example, a 2K polyurea formulation was printed in a checker board fashion using ambient reactive extrusion (ARE) manufacturing and a solid effect particle, namely glass beads. The glass bead particles were embedded into the unhardened composition. Confocal laser scanning microscopy was used to verify the extent of bead embedment into the material. DELTA LTL-X Mark II measurements were made to characterize retroreflectivity of the sample.

Two 2K formulations, formulation A and B, included a first component that included a diamine and a second component that included an aliphatic polyisocyanate. The components of the first component, were weighed into a Max 300 L DAC cup from Flacktek. The formulations were dispersed via a typical Speedmixer procedure. The components of the second component were weighed into a Max 300 L DAC cup from Flacktek. The formulations were dispersed via a typical Speedmixer procedure. Formulation A was prepared with 3% fumed silica while formulation B was prepared with 1% fumed silica. Formulation A first component had a viscosity of 30,000 cps and the second component had a viscosity of 20,000 cps. Formulation B first component had a viscosity of 13,000 cps and the second component had a viscosity of 5,000 cps. The viscosities were measured at ambient temperature (23° C.) using a Brookfield Viscometer (AMETEK.Inc.) using spindle No. 7 at 50 rpm.

The second component and the first component of both formulations were printed at a volume ratio of 2:1 and fed through a static mixing nozzle.

A first article was printed with formulation A. The first layer was applied to form a 12 inch (30.5 cm) by 5 inch (12.7 cm) rectangle at 1.5 mm thick. The first layer was made up of 1 inch (2.5 cm) by 1 inch (2.5 cm) checker board squares to form a first article.

A reservoir of Potters Type III glass beads was fixed to the extruder. A hole at the bottom of the reservoir led the beads to a screw conveyor powered by a stepper motor, similar to that shown in FIGS. 5, 6 and 7. The rotational frequency of the stepper motor was used to control the mass flow rate of beads from the reservoir or auger sleeve. The auger turned at about 90 rpm. The screw conveyor fed the beads through a funnel and into a ¼″ tube that led the beads to the tip of the static mixing nozzle.

On top of the first article, formulation B was printed with the screw conveyor activated. The extruder followed a toolpath above the first article that went incrementally along the first article's long axis and back and forth along the article's short axis forming a layer on the top surface of the first article. The glass beads were embedded to approximately half of their radius into formulation B of the printed material. The glass bead embedment was verified by using confocal laser scanning microscopy of the printed sample. The final article (including formulation A, formulation B and the glass beads was allowed to cure overnight at ambient conditions. Retroreflectivity of the sample, measured using a DELTA LTL-X Mark II, was 520 millicandelas.

Whereas particular embodiments of this disclosure have been described above for purposes of illustration, it will be evident to those skilled in the art that numerous variations of the details of the present disclosure can be made without departing from what is defined in the appended claims.

1. An article of manufacture made by ambient reactive extrusion, comprising
a) a hardenable composition; and
b) a pigment component comprising a pigment and/or a particle;
wherein the pigment component is applied to at least a portion of a surface of the article when the hardenable composition is at least partially unhardened, such that the pigment and/or the particle becomes embedded upon hardening.

2. The article of manufacture according to claim 1, wherein
the article is a three dimensional article;
and
wherein the hardenable composition is hardened after the pigment and/or particle becomes embedded.

3. The article of claim 1, wherein the pigment and/or the particle in the pigment component is incompatible with ambient reactive extrusion.

4. The article of claim 1, wherein the pigment and/or the particle is concentrated in from 0.1 wt. % 25 vol. % of a portion of the article based on the total volume of the article.

5. The article of claim 1, wherein the pigment and/or the particle is substantially uniformly distributed on a surface or a portion of a surface of the article and provides a metallic visual effect, a color effect, a luminescent effect, and/or a (retro)reflective effect, and wherein the pigment and/or the particle is substantially uniformly distributed on a predetermined pattern on the surface.

6. (canceled)

7. The article of claim 1, wherein the pigment component comprises dry pigments and/or particles, a slurry of pigments and/or particles and/or a rinse comprising pigments and/or particles dispersed in a carrier.

8. The article of claim 1, wherein
the pigment in the pigment component has a median particle size in the range of 2-75 μm; wherein median particle size is measured by laser diffraction according to ISO 13320-1 (1999).

9. (canceled)

10. The article of claim 1, wherein the pigment and/or the particle has a visual effect and/or a performance effect, wherein the pigment and/or particle comprises a corrosion inhibiting pigment, a color imparting pigment, a metallic pigment, a radar reflective pigment, a LIDAR reflective pigment, a filler pigment, a luminescent pigment, a (retro)reflective pigment, or combinations thereof, wherein the metallic effect pigments comprise aluminum, stainless steel, zinc, copper and alloys thereof and flakes thereof, wherein the pigments optionally comprise interference pigments comprising titanium dioxide-coated mica, corundum flakes, muscovite, phlogopite or biotite, mica, gold, silver, nickel, platinum, bronze, brass, titanium, tungsten, including oxides and alloys thereof.

11. The article of claim 1, wherein the particles comprise beads, wherein the beads comprise glass, metal, minerals, and/or plastics, and wherein the beads have a mean particle size of from 76 μm to 1,500 μm, such as 80 μm to 1,400 μm, 90 μm to 1,250 μm, or 100 μm to 1000 μm, determined according to ASTM D1214-10 (2020) or AASHTO M247-81 (1996), and/or wherein the particles comprise beads, wherein from 80 to 100 wt. % of the beads pass through a size 12 U.S. Mesh screen and/or from 70 to 100 wt. % of the beads pass through a size 14 U.S. Mesh screen and/or from 60 to 95 wt. % of the beads pass through a size 16 U.S. Mesh screen and/or from 5 to 60 wt. % of the beads pass through a size 18 U.S. Mesh screen and/or from 0 to 10 wt. % of the beads pass through a size 20 U.S. Mesh screen, determined according to ASTM D1214-10 (2020) or AASHTO M247-81 (1996).

12. (canceled)

13. (canceled)

14. The article of claim 1, wherein the pigment comprises a flake pigment and the article has a flop index of from 8 to 22 calculated by measuring the luminance of reflected light at viewing angles of 15°, 45°, and 110° with respect to the surface showing a change in reflectance of the article as it is rotated through the viewing angles.

15. The article of claim 1, wherein the article forms at least part of a vehicle, an article of manufacture, a consumer electronic device, a consumer appliance, a pavement, a road marking or a structure, such as a component of modular housing.

16. The article of claim 1, wherein the hardenable composition is a thermoset and comprises a first reactive component and a second reactive component, wherein:
the first reactive component comprises a polyisocyanate, such as a polyisocyanate prepolymer, a difunctional polyisocyanate prepolymer, an isocyanate-terminated polytetramethylene prepolymer, an isophorone-terminated polytetramethylene prepolymer, and combinations thereof; and the second reactive component comprising a polyamine, such as a polyamine prepolymer, a difunctional polyamine prepolymer, a trifunctional polyetheramine, and combinations thereof, wherein the first reactive component and the second reactive component react to form a polyurea-based hardenable composition; and/or
the first reactive component comprises a Michael donor group, such as an amine, thiol, enolate, alcohol, or enamine, and the second reactive component comprises a Michael accepting group, wherein the first reactive component and the second reactive component react to form a Michael addition-based hardenable composition; and/or
the first reactive component comprises a Michael donor group, such as prepolymers and/or monomers of an amine-containing compound, such as a polyamine prepolymer(s), polyamine monomer(s), or blends thereof, and the second reactive component comprises a Michael accepting group, the first reactive component and the second reactive component reacting to form an aza-Michael addition-based hardenable composition; and/or
the first reactive component comprises a Michael donor group comprising prepolymers and/or monomers of a thiol-containing compound, such as polythiol prepolymer(s), polythiol monomer(s), or blends thereof, and the second reactive component comprises a Michael accepting group, the first reactive component and the second reactive component reacting to form a thia-Michael addition-based hardenable composition; and/or
the first reactive component comprises an epoxy, such as polyepoxide prepolymer(s), polyepoxide monomer(s) or blends thereof, and the second reactive component comprises a thiol-containing compound, the first reactive component and the second reactive component reacting to form a polythioether-based hardenable composition; and/or
the first reactive component comprises a catalyst and/or activator, such as an oxidizing compound, such as metalperoxides, metal oxy-salts, and/or other oxidizing agents, or blends thereof, such as manganese dioxide, and the second reactive component comprises a thiol-containing compound, the first reactive component and the second reactive component reacting to form a polysulfide-based hardenable composition; and/or
the first reactive component comprises a thiol, such as polythiol prepolymer(s), polythiol monomer(s), or blends thereof, and the second reactive component comprises an alkylene-containing compound, the first reactive component and the second reactive component reacting to form a thiolene-based hardenable composition; and/or
the first reactive component comprises an epoxy-containing compound, such as polyepoxide prepolymer(s), polyepoxide monomer(s), or blends thereof, and the second reactive component comprises an amine-containing compound, the first reactive component and the second reactive component reacting to form an epoxy amine-based hardenable composition; and/or
the first reactive component comprises an epoxy-containing compound, such as polyepoxide prepolymer(s), polyepoxide monomer(s), or blends thereof, and the second reactive component comprises an anhydride-containing compound, such as anhydride prepolymer(s), anhydride monomer(s), or blends thereof, the first reactive component and the second reactive component reacting to form an epoxy-anhydride-based hardenable composition; and/or
the first reactive component comprises an hydroxyl-containing compound, such as polyol prepolymer(s), polyol monomer(s), or blends thereof, and the second reactive component comprises an isocyanate-containing compound, such as polyisocyanate prepolymer(s), isocyanate monomer(s), or blends thereof, the first reactive component and the second reactive component reacting to form a polyurethane-based hardenable composition; and/or
the first reactive component comprises an amine-containing compound, and the second reactive component comprises an acetate-containing compound, the first reactive component and the second reactive component reacting to form a condensation reaction-based hardenable composition.

17. The article of claim 1, wherein the hardenable composition is applied as multiple layers, wherein a first hardenable composition comprises the first layer(s) and comprises a higher amount of rheology modifier and/or filler compared to a second hardenable composition;
wherein the first hardenable composition is applied as a first layer;
wherein the second hardenable composition is applied to a surface of the first hardenable composition, making up a second layer(s);
wherein the first hardenable composition comprises from 1 wt. % to 15 wt. % of rheology modifier and/or filler and the second hardenable composition comprises from 0 wt. % to 3 wt. % of rheology modifier and/or filler, both based on the weight of the respective hardenable compositions; and wherein the amount of rheology modifier and/or filler in the first hardenable composition is greater than the amount of rheology modifier and/or filler in the second hardenable composition.

18. An article according to claim 17, wherein the resulting viscosity of the first and second hardenable compositions is from 1 cps to 1,000,000 cps determined using a Brookfield Viscometer (AMETEK.Inc.) using spindle No. 7 at 50 rpm and 23° C.; wherein the viscosity of the uncured first hardenable composition is greater than the viscosity of the second hardenable composition and wherein the pigment component is applied to a surface of the second hardenable composition.

19. (canceled)

20. (canceled)

21. (canceled)

22. (canceled)

23. An article according to claim 1, wherein the hardenable composition is printed by ambient reactive extrusion in layers, wherein one or more layers comprise a rigid portion, a flexible portion, a foam-like portion, a tactile portion, two or more portions comprising different densities, a conductive portion, a thermally conductive portion, an electrically conductive portion, different colors, different rheological profiles, and/or different materials comprising different affinities for water and/or solvent(s).

24. An article according to claim 1, wherein the hardenable composition is deposited onto an existing article, such as an article comprising a thermoset, a thermoplastic, a metal, wood, a composite material, a ceramic, asphalt or combinations thereof.

25. (canceled)

26. (canceled)

27. A method of making the article of claim 1 comprising:
using ambient reactive extrusion to deposit a hardenable composition to form a three dimensional article;
applying a pigment component comprising a pigment and/or a particle to at least a portion of a surface of the article when the hardenable composition is at least partially unhardened; and
hardening the hardenable composition.

28. The method according to claim 27, wherein
the article is a three-dimensional article, and
the hardenable composition is applied by forming successive portions or layers by depositing the hardenable composition onto a substrate and thereafter depositing additional portions or layers of the hardenable composition over the underlying deposited portion or layer; wherein the layers are successively deposited to build the three-dimensional article and wherein covalent bonds may form between layers;
wherein the pigment component is applied by spraying, rinsing, dipping, electrostatically, vibratory expulsion, screw conveyer, and/or auger; and
wherein the screw conveyer comprises an auger sleeve in fluid communication with an auger adapted to discharge the pigment component via an auger discharge.

29. (canceled)

30. (canceled)

31. A screw conveyor comprising an auger sleeve, adapted to receive a pigment component comprising pigments and/or particles, in fluid communication with an auger, in fluid communication with an auger discharge, adapted to convey the pigment component from the auger sleeve to the auger discharge, a motor adapted to turn the auger, an auger housing surrounding the auger.

32. The screw conveyor according to claim 31, wherein the auger discharge is adapted to receive a funnel that is adapted to direct the application of the pigment component;
wherein the auger is from 2 cm to 15 cm long, comprises a multitude of flights that extend from an auger shaft an inner wall of the auger housing;
wherein the flights have a width of from 0.2 cm to 2.5 cm and the flights are spaced apart by from 0.5 cm to 4 cm; and/or
wherein the motor turns the auger at from 1 rpm to 180 rpm.

33. (canceled)

34. (canceled)
